(19) United States
(12) Patent Application Publication
(10) Pub. No.: US 2013/0228421 A1
(43) Pub. Date: Sep. 5, 2013

(54) Sprocket for easy cleaning

(71) Applicant: Anthony T. Harrelson, Archdale, NC (US)

(72) Inventor: Anthony T. Harrelson, Archdale, NC (US)

(73) Assignee: White Oak Industries Inc., Archdale, NC (US)

(21) Appl. No.: 13/385,673

(22) Filed: Mar. 1, 2012

(51) Int. Cl. B65G 23/06

(52) U.S. Cl. 198/834

(57) ABSTRACT

A two-material plastic sprocket for modular plastic conveyor belts and an associated method for molding such a sprocket. The sprocket is made of a first plastic material forming the exterior and a second plastic material forming the interior core using co-injection molding. The invention relates generally the sprockets used to drive modular plastic conveyor belts and, more particularly, to sprockets molded out of two plastic materials.

### BACKGROUND OF INVENTION

the present invention relates to a modular conveying apparatus. The invention relates generally the sprockets used to drive modular plastic conveyor belts and, more particularly, to sprockets molded out of two plastic materials.

Modular plastic conveyor belts are used in a wide range of conveyor applications. Unlike flat belts, which are driven by tensioned rollers or pulleys, modular plastic conveyor belts are driven by sprockets, which positively engage drive structure in the belts. The most common sprockets are molded or machined out of one homogeneous plastic or metal material. In this instance the sprocket material is chosen to best match the application. In some instances, the properties of a single material may serve some of the needs of an application well, but may be less than optimum for other needs. For example, in an abrasive environment, a sprocket made entirely of polyurethane or nylon which has good abrasion-resistant properties, but may be less than optimum for other needs. As another example, glass-filled materials provide strength and firmness to plastic articles, but are too abrasive in contact with a belt when used continually. Thus, there is a need for a sprocket that combines the best properties of various materials to accommodate a wide range of applications and increasing tensile strength, deflection, temperature variation, shear strength, along with improved creep resistance. The invention design provides dimensional stability and lower thermal expansion.

Sprockets for driving modular belts are usually made from stainless steel or plastic that is machined or molded. In food processing applications, sprocket drives are a particularly critical area for cleaning. It is important to be able to periodically remove the residual matters totally from the sprockets and on the rear side of the belt, in order to avoid bacteria growth and spoilage of the food processed on the belt. For this purpose sprockets have been designed with large openings to allow cleaning fluid to pass from the side and reach the critical areas to be cleaned and smooth exterior surfaces to prevent growth of bacteria.

typically, the sprocket rim and teeth are covering the hinges and hinder the fluid from reaching the hinge area for proper cleaning. Therefore the sprocket disclosed in the patent further provides pairs of teeth in a double row such that the teeth of a pair are offset. This arrangement allows better cleaning access to the rear belt side and easier release of residual matters collected on the rear belt side. But this design is only partially solving the problem since the critical hinge areas are still covered by the sprocket rim to a certain extent, when engaged on the sprocket. Therefore good access to these hinges is of primary importance.

### SUMMARY OF INVENTION

These needs and others are satisfied by a sprocket embodying features of the invention. The sprocket comprises an exterior skin (exterior here on) and an integrally molded interior core. The exterior is molded of a first plastic material, and the core is molded of a second plastic material. In this way, the sprocket can combine the advantageous properties of both materials to better address a given application.

The present invention meets the above described need by providing a drive sprocket for driving a modular belt having a plurality of belt modules with intercalated link ends connected by transverse pivot members to form hinges. The belt modules may have transverse ribs. The drive sprocket is driven by a shaft. The drive sprocket has a central opening for receiving the shaft.

The body has a plurality of teeth disposed in pairs along a periphery of the body. The body has a first opening formed between adjacent pairs of teeth and extending toward the center of the sprocket to provide access to the hinge area, when the belt engages with the sprocket, for application of cleaning fluid.

the sprocket may also be provided with a curved recessed portion adjacent to the first opening. A plurality of second openings may be disposed in the body of the sprocket between the central opening and the first opening.

the pairs of teeth may be arranged in offset fashion with respect to a central axis or the teeth may extend for the entire with of the sprocket.

a cleaning system may be arranged proximate to the sprockets such that cleaning fluids are sprayed through the curved recessed portion into the opening disposed adjacent to the hinge of the belt when the belt engages with the sprocket. The cleaning system may include a manifold in combination with spray heads pointed toward the sprocket.

in another aspect of the invention, a method for molding a sprocket is provided. The co-injection or sandwich method is used to produce this invention. According to the method, a first plastic material is injected into a cavity defined by inner walls of a sprocket mold to form an exterior coating the walls. A second plastic material is injected into the sprocket mold cavity inside the exterior. Pressure and heat are applied to the mold to form the sprocket. This gives the sprocket higher core strength and improved aesthetics.

### BRIEF DESCRIPTION OF DRAWINGS

These and other features, aspects, and advantages of the invention are better understood by reference to the following description, appended claims, and accompanying drawings, in which:

FIG. 1 is an isometric view of a sprocket embodying features of the invention;

FIG. 2 is a cross section of the sprocket of FIG. 1 taken along lines II-II;

FIG. 3 is a cross section of the sprocket of FIG. 1 taken along lines III-III; and

FIGS. 3A-3E is partial cross sectional views illustrating a co-injection molding process for making a sprocket as in FIG. 1.

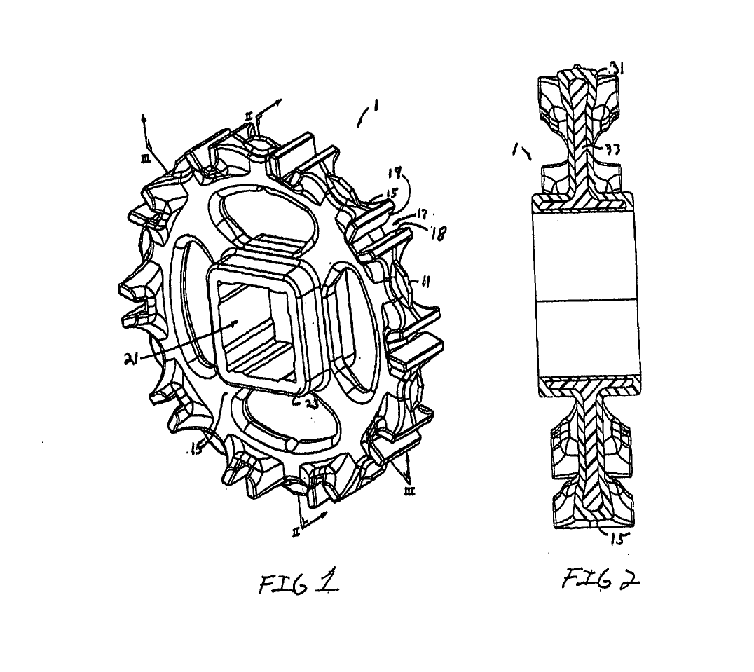

### DETAILED DESCRIPTION

Ten tracking teeth 11 are spaced around the circumferential periphery 15 of the sprocket. Midway between consecutive tracking teeth are grooves 17 with leading and trailing driving surfaces 19, 18 for engaging complementary drive surfaces on a modular plastic conveyor belt. The sprocket also forms a central axial bore 21, shown as generally square to receive a square shaft. A hub 23 around the bore extends axially in the width direction of the sprocket farther than the other parts of the sprocket. Spokes 25 extend from the hub to the outer periphery and divide the sprocket into four regions 16A-D. An opening 24 formed in each region makes the sprocket easy to clean and lighter in weight.

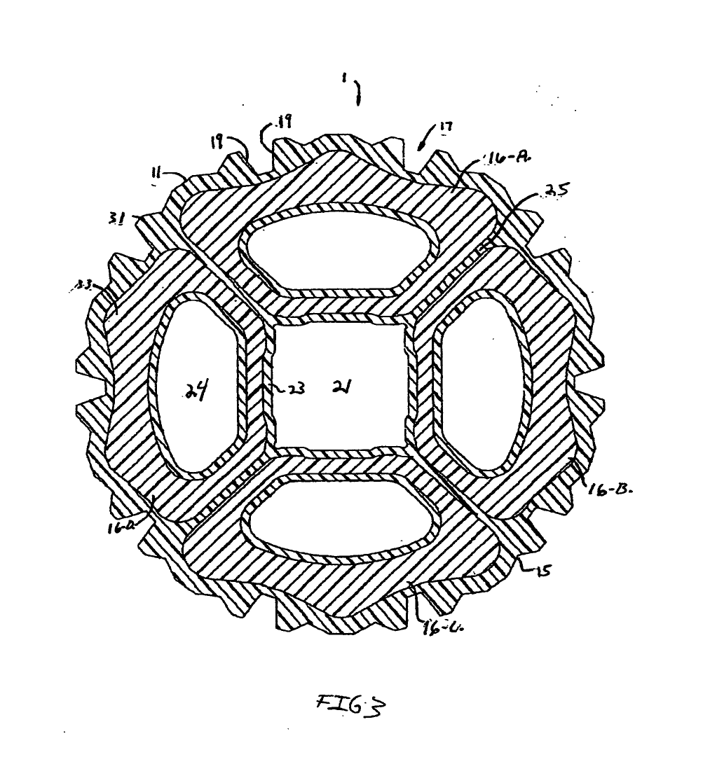

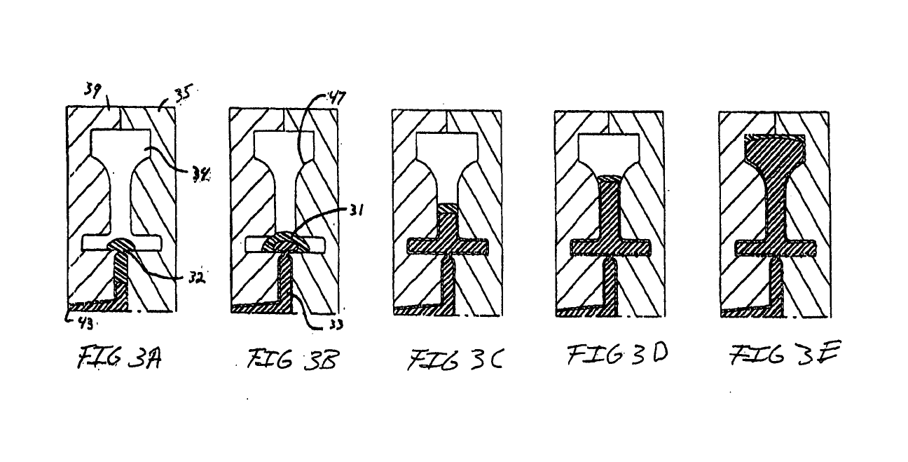

As illustrated in the cross sections of FIGS. 2 and 3, the sprockets, which include an exterior 31 and an interior core 33, are made of two materials. The teeth, the peripheral structure, and the exterior of the sprocket are made of a first plastic material. The interior core, which includes the interior portion of the four regions, is made of a second plastic material. The materials are preferably integrally molded together into a unitary sprocket in a co-injection molding process. Various combinations of exterior and core materials.

As the examples in the table suggest (see table one), the co-injection molded sprocket of the invention combines the desirable properties of different materials to make a range of sprockets with properties not achievable with conventional sprockets formed of a single homogeneous material. For example, glass-filed plastics are extremely strong and rigid, but are notoriously abrasive. But, when used to form the core and covered by the exterior, the glass-filled material does not contact other parts in relative motion. In this way, the sprocket adds the low-abrasion advantages of the chosen exterior material to the strength and rigidity of the glass-filled material.

The sprocket is molded as shown in FIGS. 3A-3E Two mold halves 39, 35, when closed together, form a cavity 34, in which the sprocket is formed. The cavity is bounded and defined by inner walls 47 of the mold halves. Molten thermoplastic material is injected into the cavity from the barrel of an injector (not shown) into a runner 43 and through a gate 36. In a co-injection molding process, two materials are injected through the same runner and gate. As shown in FIG. 3A-3E, the first plastic material 31 forming the outside of the sprocket is injected first. As the first plastic material enters the cavity, it coats the walls 47 of the cavity and the inner surface of the runner.

The second plastic material 33 is injected into the runner inside the first plastic material. The injection process continues in sequence as depicted in FIGS. 3A-3E until the cavity is filled with both materials al II I the first plastic material forming the exterior and the second 1° plastic material forming the interior core. Preferably, the ′ is no less than about 0.31 mm thick and generally encapsulates the interior core, except perhaps at the positions of the gates. Heat and pressure are then applied in the molding process to form the two-material sprocket of the invention.

Thus, the invention has been shown in detail with reference to a specific example, but other exemplary versions of the invention are possible. For example, sprockets having other tooth bore, hub, and peripheral configurations can be made. The material pairings listed in the table provide just some examples of materials that could be used. The exterior material and the core material may be molded out of materials having different colors to indicate wear of the exterior.

So, as these few examples suggest, the invention is not restricted to the particular embodiment described and illustrated, but includes all embodiments and modifications that may fall within the scope of the appended claims.

What is claimed is:

1. A sprocket for a modular plastic conveyor belt, the sprocket comprising:
an exterior ′ made of a first plastic material; and an interior core integrally molded with the exterior and made of a second plastic material; and further comprising peripheral sprocket teeth forming part of the exterior and molded entirely of the first plastic material, wherein the interior core is completely encapsulated by the exterior.
TABLE 1

| EXTERIOR | | |
|---|---|---|
| MATERIAL | CORE MATERIAL | PROPERTIES |
| POLYURETHANE | POLYURETHANE | STRONG EXTERIOR RIGID |
| | | INTERIOR |
| POLYURETHANE | POLYURETHANE | STRONG EXTERIOR RIGID |
| | NYLON GLASS | |
| ACETAL | POLYURETHANE | ABRASION RESIDTANT |
| | NYLON GLASS | |
| | REGROUND | EXTERIOR ECONOMICAL |
| | ACETAL | |
| NYLON | GLASS FILLED | CORE LOW FRICTION |
| | | EXTERIOR |
| | POLYPROPYLENE | |
| POLYPROPYLENE | ACATEL BLEND | |
| | ELASTOMER | |
| TEFLON | THERMO | |
| | PLASTIC | |
| | NEAT PLASTIC | |
| ANTIMICROBIAL | | LOW FRICTION EXTERIOR |
| ADDITIVE IN | ACETAL | RIGID CORE |
| MATERIAL | | ANTIMICROBIAL |
| | | EXTERIOR |
| | | INEXPENSIVE CORE |
| CONDUCTIVE | ACETAL | ANTI STATIC |
| ADDITIVE | | |
| IN MATERIAL | | EXTERIOR |

2. A sprocket as in claim 1 wherein the first plastic material is selected from the group consisting of: polyurethane, polypropylene, acetal, and TEFLON.

3. A sprocket as in claim 1 wherein the first plastic material includes an electrically conductive additive.

4. A sprocket as in claim 1 wherein the second material is selected from the group consisting of: glass-filled polyurethane; glass-filled polypropylene; nylon; foamed polypropylene; reground polypropylene, polyethylene, acetal, or nylon; SANTOPRENE;
and a polyurethane and acetal blend, polyolefin.

5. A sprocket as in claim 1 wherein the first and the second plastics are colored differently.

6. A sprocket as in claim 1 wherein the second plastic material is glass-filled.

7. A sprocket as in claim 1 wherein the second plastic material includes reground plastic.

8. A sprocket as in claim 1 wherein the second plastic material is more flexible than the first plastic material.

9. A sprocket as in claim 1 wherein the first plastic material is more flexible than the second plastic material.

10. A sprocket as in claim 1 wherein the sprocket is formed in a co-injection molding process.

11. A sprocket as in claim 1 wherein the exterior is no less than about 0.31 mm thick.

12. A sprocket as in claim 1 wherein the first plastic material includes an antimicrobial additive.

13. A sprocket for a modular plastic conveyor belt, the sprocket comprising:
an exterior made of a first plastic material; and an interior core integrally molded with the exterior.

14. A sprocket made of a second plastic material; wherein the first plastic material includes an antimicrobial additive.
